(19) United States
(12) Patent Application Publication
(10) Pub. No.: US 2003/0185414 A1
(43) Pub. Date: Oct. 2, 2003

(54) Systematic sound receiving device for microphones

(76) Inventor: Shih Yuan Liu, Hsin Dian City (TW)

Correspondence Address: BRUCE H. TROXELL, SUITE 1404, 5205 LEESBURG PIKE, FALLS CHURCH, VA, 22041, US

(21) Appl. No.: 10/106,244

(22) Filed: Mar. 27, 2002

(51) Int. Cl. H04R 9/08; H04R 11/04; H04R 17/02; H04R 19/04; H04R 21/02

(52) U.S. Cl. 381/361; 381/363

(57) ABSTRACT

A systematic sound receiving device for microphones, wherein, a box is provided therein with multiple speakers facing toward a bottom panel provided with sound outgoing holes, the box is mounted on both the front and rear sides thereof with a line of microphone supports which most preferably each includes a flexible tube; one end of the flexible tube is connected to the box, while the other end thereof is assembled with a microphone clamp. In this way, the microphones can be systematically collected and hung, and can be adjusted for receiving sound in a close distance.

### BACKGROUND OF THE INVENTION

1. Field of the invention

The present invention is related to a systematic sound receiving device for microphones, and especially to such a device of which the microphones can be systematically collected and hung, the device particularly suits the sites where a crowd of reporters are gathering news.

2. Description of the Prior Art

Internet can transmit information very fast without limitation of boundaries of countries; however generally, release of news in a country or a district is done mainly by a press conference.

As a result of democratization and press liberalization, a press conference with a high press value generally is crowed with many reporters for gathering news; such a public appearance normally is quite confused. The table of a callee or a news announcer is placed confusedly with many microphones, and reporters may take microphones in front of the spokesman with their hands, the outside reporters have to hang microphones on lengthy rods for receiving sounds.

The defect encountered most frequently in such a press conference having many microphones is that, the picture of the spokesman is nearly completely obscured by the microphones in front of him or her, and no ideal picture can be taken. Moreover, the reporters unable to place their microphones on the table of the spokesman at the earliest moment must hold the microphones in their hands all the way during gathering news, hence are very tiered. Additionally, the microphones of some media are relatively remoter from the spokesman; the sounds received by them include echoes and thereby are undesired.

### SUMMARY OF THE INVENTION

The object of the present invention is to provide a systematic sound receiving device for microphones, the microphones can be collected and hung for receiving sounds at the spots spaced with equal intervals, thereby, the confused picture in front of the spokesman can be eliminated; reporters can get rid of holding microphones with hands, and they can get the effect of sound receiving as obtained at a close distance to the spokesman.

To obtain the object, the present invention is provided with a box of suitable size and volume, the box can be provided therein with multiple speakers facing toward a sound wave emitting bottom panel provided with sound outgoing holes. Multiple flexible tubes in a line are connected with one end of each of them to the box, and with the other end of each to a microphone clamp which is used to clamp one of the microphones, the microphones can be adjusted to face the sound wave emitting bottom panel and multiple speakers provided in the box.

The present invention will be apparent in its novelty and other features after reading the detailed description of the preferred embodiment thereof in reference to the accompanying drawings.

### BRIEF DESCRIPTION OF THE DRAWINGS

FIG. 1 is a perspective view of a preferred embodiment of the present invention;

FIG. 2 is a schematic sectional view taken form FIG. 1 showing microphones are hung on;

FIG. 3 is a schematic view showing adjustment of a microphone.

### DETAILED DESCRIPTION OF THE PREFERRED EMBODIMENT

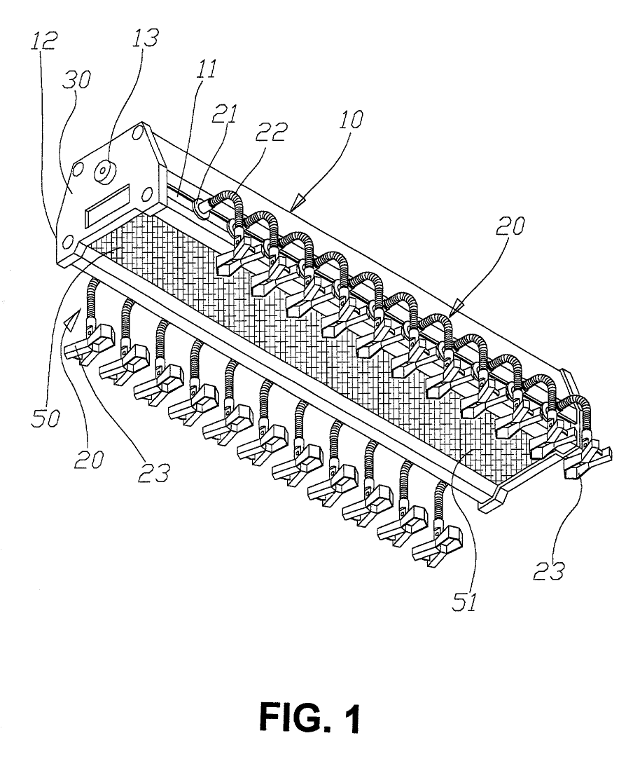

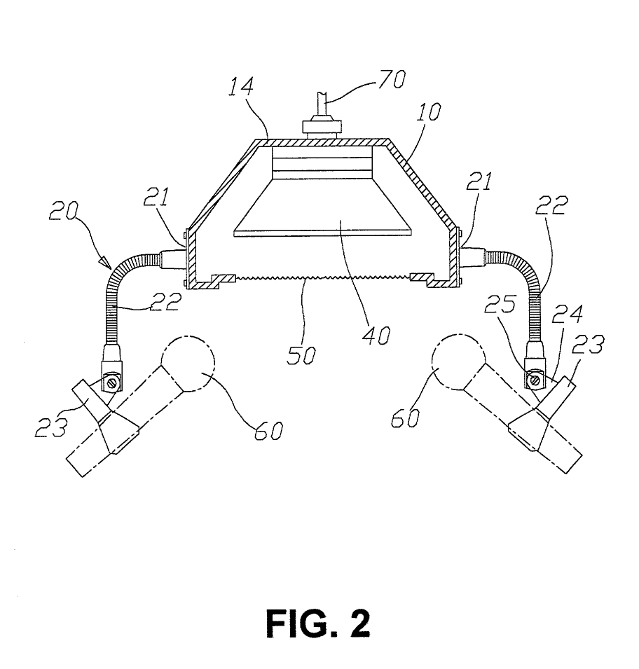

Referring to FIGS. 1 and 2, in the preferred embodiment, the present invention is provided with a box 10 of suitable size and volume, the box 10 has a front side 11 and a rear side 12 with a larger length each, and has a height and a lateral side wide which are predetermined, the box 10 is provided for receiving therein multiple speakers. The front side 11 and the rear side 12 are mounted thereon with multiple microphone supports 20.

In the preferred embodiment shown, the box 10 is in the form of a cabinet assembled with two lateral side covers 30, the top thereof is closed and the bottom surface thereof is opened. The front side 11 and the rear side 12 of the box 10 are mounted thereon with the microphone supports 20, one of the two lateral side covers 30 is provided with an exposed power-adjusting knob 13. The microphone supports 20 in the preferred embodiment shown in the drawings each includes a flexible tube 22, one end of the flexible tube 22 is connected to the front side 11 or the rear side 12 of the box 10 through a member such as a protruding piece 21, while the other end of the flexible tube 22 is connected to a movable microphone clamp 23. In the preferred embodiment shown in the drawings, the microphone clamps 23 are all movably and pivotally connected with the ends of the corresponding flexible tubes 22 by means of pivot connecting pieces 24. The pivot axles 25 of the pivot connecting pieces 24 can be the rotation axles for swiveling.

As shown in FIG. 2, the box 10 is provided therein with multiple speakers 40 in a number according to the length of the box 10, and has a function as that of an amplifier; alternatively, the speakers 40 can be driven by an amplifier provided outside of the box 10. A bottom panel 50 with a lot of sound outgoing holes 51 is provided below the speakers 40.

The entire box 10 in the preferred embodiment thereby can be added on the top surface 14 thereof with a hanging rod 70 as depicted in FIG. 2 for the purpose of mounting the present invention by hanging.

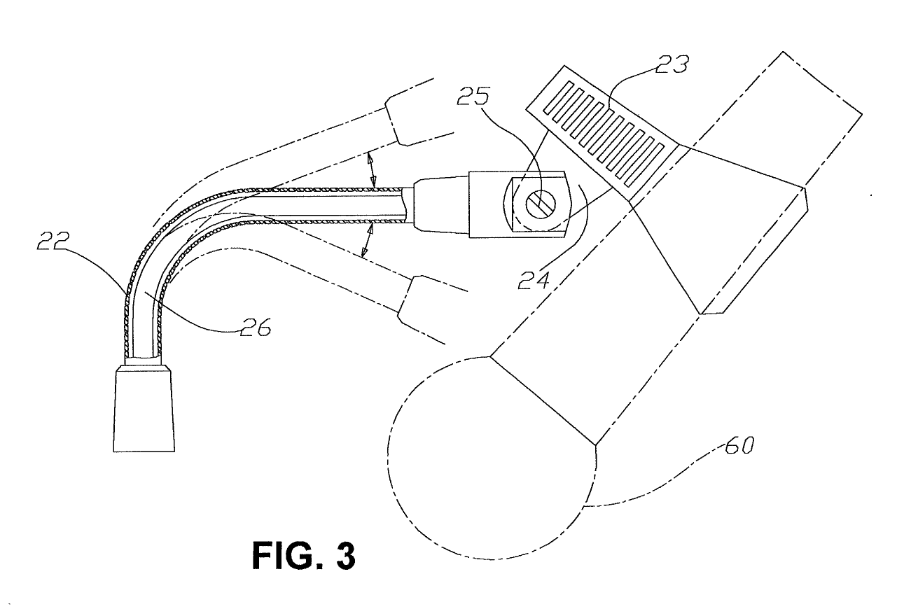

The flexible tubes 22 may generate rebound of some degree after bending to influence acquiring of their proper positions; as is shown in FIG. 3, to overcome this problem, the flexible tubes 22 can be installed therein each with a metallic rod 26 made from metallic wires to resist such rebound. Thereby, the flexible tubes 22 can be positioned at the desired positions after bending adjustment.

As shown in FIG. 3, after a microphone clamp 23 is inserted therein with a microphone 60, the entire corresponding flexible tube 22 can be adjusted toward the desired direction about the joint of it with the box 10 as a fulcrum. The microphone 60 can then be adjusted within its largest extent to move toward the location where its corresponding speaker 40 is, to make sound receiving at a close distance.

The present invention thereby can systematically collect and hang the microphones to solve the problem of confusion of the picture before a spokesman. When the present invention is hung above a spokesman's table, the spokesman will be no obscureness at all. And more, another advantage is that, reporters need not to hold the microphones in their hands all the way during gathering news, and they can make more desired sound receiving at a close distance.

The preferred embodiment are only for illustrating the present invention. It will be apparent to those skilled in this art that various modifications or changes can be made to the elements of the present invention without departing from the spirit and scope of this invention. Accordingly, all such modifications and changes also fall within the scope of the appended claims and are intended to form part of this invention.

1. A systematic sound receiving device for microphones, said device comprises: a box of a predetermined size and volume, said box has a front side and a rear side, and has a top surface and two lateral sides forming said box in cooperation with said front and rear sides, and is provided with a bottom panel provided with sound outgoing holes;
a plurality of adjustable microphone supports in lines are mounted on said front and rear sides of said box, one end of each of said microphone supports is connected with said box, while the other end is pivotally connected with a microphone clamp which is used to clamp a microphone; said box is provided therein with a plurality of speakers facing toward said bottom panel provided with said sound outgoing holes.

2. The systematic sound receiving device as claimed in claim 1, wherein,
said microphone supports each includes a flexible tube, one end of said flexible tube is connected to said front side or said rear side of said box through a protruding piece, while the other end of said flexible tube is movably and pivotally connected to a microphone clamp.

3. The systematic sound receiving device as claimed in claim 2, wherein,
said flexible tubes is installed therein with a metallic rod made from metallic wires.

4. The systematic sound receiving device as claimed in claim 1, wherein,
said entire box is added on the top surface thereof with a hanging rod.

5. The systematic sound receiving device as claimed in claim 1, wherein,
said box is provided on one of said two lateral sides with a power-adjusting knob.
